(19) United States
(12) Patent Application Publication
(10) Pub. No.: US 2005/0033469 A1
(43) Pub. Date: Feb. 10, 2005

(54) Working time period grasping system and work instruction preparing system

(76) Inventors: Masato Matsuzaki, Aichi-ken (JP); Tadao Konishi, Aichi-ken (JP); Takashi Kobayashi, Aichi-ken (JP); Minoru Mitsuoka, Aichi-ken (JP)

Correspondence Address: MORGAN & FINNEGAN, L.L.P., 3 WORLD FINANCIAL CENTER, NEW YORK, NY, 10281-2101, US

(21) Appl. No.: 10/878,714

(22) Filed: Jun. 28, 2004

(30) Foreign Application Priority Data
Aug. 6, 2003 (JP) 2003-288059

(51) Int. Cl. G06F 19/00

(52) U.S. Cl. 700/111; 700/306; 700/83

(57) ABSTRACT

A working time period grasping system includes: an input unit having a start button for a worker to input start of a product manufacturing work and a completion button for the worker to input completion of the product manufacturing work; and a time period detection unit for detecting a working time period of the product manufacturing work based on information input from the input unit.

### BACKGROUND OF THE INVENTION

1. Field of the Invention

The present invention relates to a system for grasping a working time period of a product manufacturing process and to a system for preparing work instructions based on the working time period grasped.

2. Description of the Related Art

There have been proposed numerous techniques for achieving an improvement in work efficiency in plants or the like for manufacturing products.

For example, there is described, in JP2000-322119A, paragraphs 0037 through 0054, a system which is equipped with a terminal for the worker to input start/completion of a work for each process and in which the progress of the process is grasped based on the information input through the terminal. In this system, it is possible to grasp in real time the progress of a production process, so that it is possible to achieve an improvement in production efficiency.

Further, there is described, in JP 2000-296443A, FIG. 5 and paragraphs 0020 through 0033, a method for making a judgment as to whether process adjustment is necessary or not based on information indicating the progress of a work and on an evaluation constant prepared in advance.

Further, there is described, in JP 2000-24850A, FIGS. 2, 6, and 7 and paragraphs 0015 through 0050, a method in which information indicating the working time period for each assembly line constitution is prepared in advance and in which the work efficiency of the assembly line is evaluated by utilizing the information.

Furthermore, there is described in JP 2000-354943A, FIGS. 1 and 2, paragraphs 0022 through 0035, a method in which information indicating worker movement, biological information, sound information, information indicating the ambient environment, etc. are collected and analyzed, thereby avoiding human errors.

To enhance production work efficiency, it is necessary to accurately grasp the actual working time period for each process and to draft a production plan based on the working time period thus grasped, thereby preparing work instructions. However, no prior-art technique provides a method that helps to accurately measure the working time period for each process with ease. Conventionally, the working time period has been measured by a measuring person by using a stopwatch. Alternatively, the way the worker works has been video-shot, measuring the working time period while reproducing the image thus recorded. Thus, the working time period measurement itself has required a lot of labor.

### SUMMARY OF THE INVENTION

It is an object of the present invention to provide a method that helps to accurately grasp with ease the working time period for each process in a product manufacturing plant. It is another object of the present invention to prepare proper work instructions based on the working time period thus grasped.

A working time period grasping system according to the present invention includes: an input means having a start button for a worker to input start of a product manufacturing work and a completion button for the worker to input completion of the product manufacturing work; and a time period detection means for detecting a working time period of the product manufacturing work based on information input from the input means.

In the above system, when starting work, the worker inputs work start information by using a start button, and, upon completion of the work, inputs work completion information by using a completion button. Then, based on the information input by the worker, the detection means detects the working time period for the work concerned. Thus, it is possible to grasp the working time period for the work without relying on any person dedicated to working time period measurement. Further, in measuring the working time period, it is only necessary for the worker to perform input operation by using buttons displayed on input means, which involves little burden on the worker.

In the above working time period grasping system, the input means maybe further equipped with a temporary stop button for allowing the operator to input interruption of the work. In this case, the detection means detects the working time period for the work based on the input by the start button, the completion button, and the temporary stop button. Due to this arrangement, it is possible to grasp the working time period even when the work is temporarily interrupted.

Further, in the above working time period grasping system, the input means may be a display device equipped with a touch panel function. In this case, the above buttons are displayed on the display device. By pressing the buttons displayed on the display device, the worker inputs information indicating work start timing or work completion timing. In this arrangement, the burden on the worker is very small, and there is no general deterioration in work efficiency.

Further, the above working time period grasping system may also have an output means for displaying work instructions at a predetermined position with respect to the input means. In this case, the detection means detects the working time period in correspondence with the work instructions as displayed. In this arrangement, it is possible to verify the working time period of the actual work in relation to work instructions prepared in advance.

Further, a work instruction preparing system according to the present invention includes: an input/output means for a product manufacturing work including a plurality of processes, the input/output means having a start button for a worker to input start of a work for each the process and a completion button for the worker to input completion of the work; a time period detection means for detecting a working time period for each process based on information input from the input/output means; and a preparation means for preparing work instructions related to the product manufacturing work including the plurality of processes based on the working time period for each process detected by the time period detection means.

In the above system, the input/output means and the detection means are basically the same as those of the working time period grasping system described above. The preparation means prepares work instructions for the worker based on the working time period for each process as grasped by the working time period grasping system. Thus, it is possible to prepare proper work instructions based on an accurately measured working time period without relying on a person dedicated to the measuring of the working time period or involving a heavy burden on the worker, thereby achieving an improvement in terms of work efficiency.

In the above system, it is also possible for the input/output means to display work instructions prepared by the preparation means. In this arrangement, the apparatus for presenting work instructions to the worker also serves as the apparatus to be used by the worker for the purpose of measuring the working time period, thereby achieving space saving and a reduction in cost.

Further, in the above system, the input/output means may be further equipped with a loss time period button for allowing the worker to input the start and end of a period not directly related to product manufacturing work. Further, in this case, the detection means detects the loss time period based on the information input through the loss time period button. Further, the preparation means prepares work instructions for the work for manufacturing products by the plurality of processes based on the working time period for each process and the loss time period. In this arrangement, it is possible to prepare work instructions taking into account the loss time period not directly related to the actual work, so that it is possible to provide the worker with proper instructions in conformity with the actual condition.

In accordance with the present invention, it is possible to easily measure and grasp the working time period for a work for manufacturing products without relying on a person dedicated to measurement. Further, it is possible to prepare proper work instructions based on the working time period for each process thus grasped, so that it is possible to achieve a general improvement in terms of work efficiency.

### BRIEF DESCRIPTION OF THE DRAWINGS

FIG. 1 is a diagram for illustrating an environment in which a working time period grasping system and a work instruction preparing system according to an embodiment of the present invention are to be used;

FIG. 2 is a flowchart illustrating a method of preparing work instructions;

FIG. 3 is a diagram showing an example of work instructions displayed on a function panel device;

FIG. 4 is a diagram showing a time period measurement screen;

FIG. 5 is a diagram for illustrating the operation of the worker when measuring the working time period;

FIG. 6 is a diagram showing an example of work information stored in a database;

FIG. 7 is a flow chart illustrating a processing for registering work information;

FIG. 8 is a diagram showing a loss time period input screen;

FIG. 9 is a diagram showing a result confirmation screen;

FIG. 10 is a diagram showing a defect input screen;

FIG. 11 is a diagram for illustrating a method of preparing work instructions;

FIG. 12 is a diagram showing a time period measurement screen according to another embodiment of the present invention; and

FIG. 13 is a diagram for illustrating the operation of the worker when measuring the working time period according to another embodiment of the present invention.

### DESCRIPTION OF THE PREFERRED EMBODIMENTS

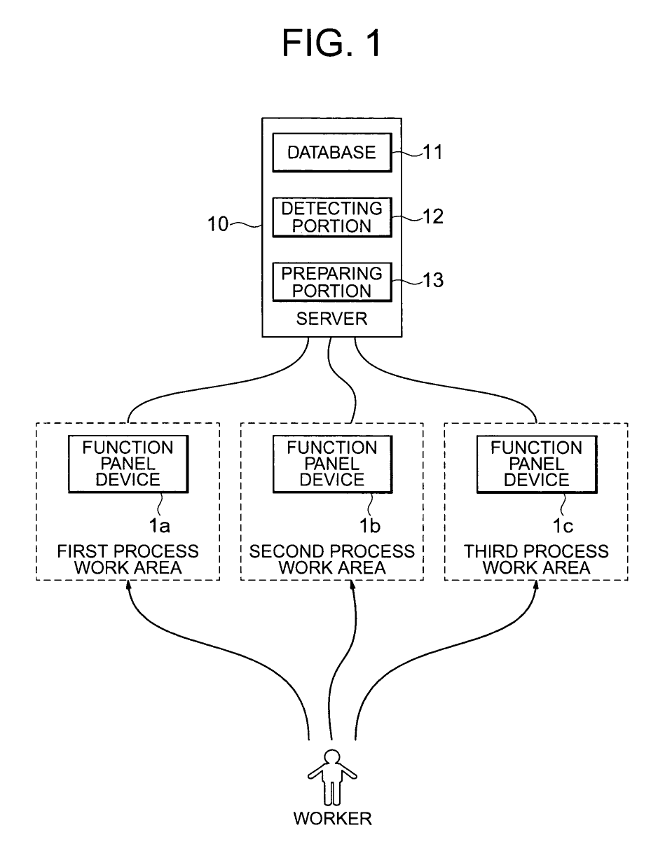

FIG. 1 is a diagram illustrating an environment in which a working time period grasping system and a work instruction preparing system according to an embodiment of the present invention are to be used. Here, it is to be assumed that the system of this embodiment is applied to a production line in a plant where products are manufactured by a plurality of working processes. Further, it is to be assumed that the production line is not a dedicated line used solely for the manufacturing of predetermined, specific products but a general-purpose line that allows processing/assembly of a plurality of kinds of products and parts by changing the tool, jig, etc. However, the present invention does not exclude application to a dedicated line.

Function panel devices (input means or input/output means) 1a through 1c are respectively provided in first through third process working areas. Here, the first through third process working areas are respectively provided with machines (processing machines, assembling machines, etc.) to be used in the first through third processes. It is to be assumed that the first through third processes constitute a part of a process for manufacturing a product and that they are performed by a single worker. That is, the worker performs the first through third processes in parallel while moving from the first through third process working areas.

The function panel devices 1a through 1c are display devices endowed, for example, with a touch panel input function and connected to a server 10 through a LAN or the like. Further, in cooperation with the server 10, the function panel devices 1a through 1c display screens for displaying work instructions to be presented to the worker and allowing the worker to input work information. Further, the function panel devices 1a through 1c are endowed with a function by which they transmit the work information input by the worker to the server 10. The work information will be explained in detail below.

The server 10 is realized by a computer, and is equipped with a database 11, a detecting portion (detection means) 12, and a preparing portion (preparation means) 13. The database 11 stores the work information sent from the function panel devices 1a through 1c. The detecting portion 12 detects the working time period for each process based on the work information stored in the database 11. The preparing portion 13 prepares work instructions to be presented to the worker based on the working time period for each process as detected. Then, the work instructions are sent to the corresponding one of the function panels 1a through 1c as needed for display.

In the above environment, the working time period grasping system of this embodiment is realized by the function panel devices 1a through 1c and the detecting portion 12. The work instruction preparing system of this embodiment is realized by the function panel devices 1a through 1c, the detecting portion 12, and the preparing portion 13. While in the example shown in FIG. 1 the detecting portion 12 is provided in the server 10, this should not be construed restrictively; it is also possible to provide the detecting portion 12 in each of the function panel devices 1a through 1c. It is to be noted that, in this case, the working time period for each process is detected by each of the function panel devices 1a through 1c, so that information indicating the working time period is transmitted to the server 10, which prepares work instructions based on the information.

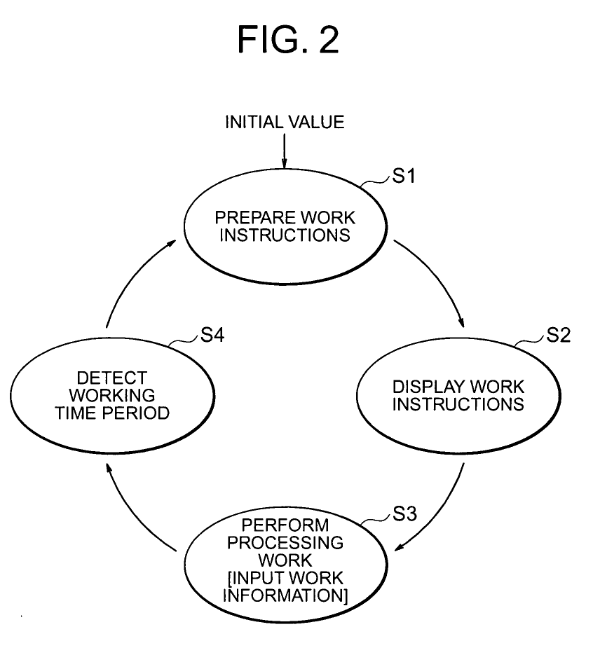

FIG. 2 is a schematic flowchart illustrating a method of preparing work instructions. First, in step S1, temporary work instructions are prepared by using an initial value prepared in advance. As the initial value, a working time period detected in the past with respect to a similar work is used. This processing is executed by the preparing portion 13 of the server 10. Next, in step S2, the work instructions prepared are displayed on the function panel devices 1a through 1c.

In step S3, the worker performs the corresponding work (processing work, assembling work, or the like) in accordance with the work instructions as displayed on the function panel devices 1a through 1c. At this time, the function panel devices 1a through 1c display, through selective operation by the worker, a screen for inputting work information. Then, by utilizing the screen, the worker inputs work information (including information indicating the start, temporary stop, re-start, and completion of the work). As stated above, the work information input is sent to the server 10.

In step S4, the working time period for each process is detected based on the work information sent from the function panel devices 1a through 1c. Here, this processing is executed by the detecting portion 12 of the server 10. When the working time period for each process has been detected, the procedure returns to step S1, where work instructions for the next work are prepared based on the working time period detected in step S4.

In this way, by executing steps S1 through S4, work instructions are prepared using the working time period actually measured. At this time, when steps S1 through S4 are repeatedly executed, the actual working time period spent by the worker and a target time incorporated in the work instructions gradually come to be matched with each other. As a result, it is possible to draft a production p1 an based on an accurate working time period and to prepare suitable work instructions for conducting an efficient work.

### EXAMPLE 1

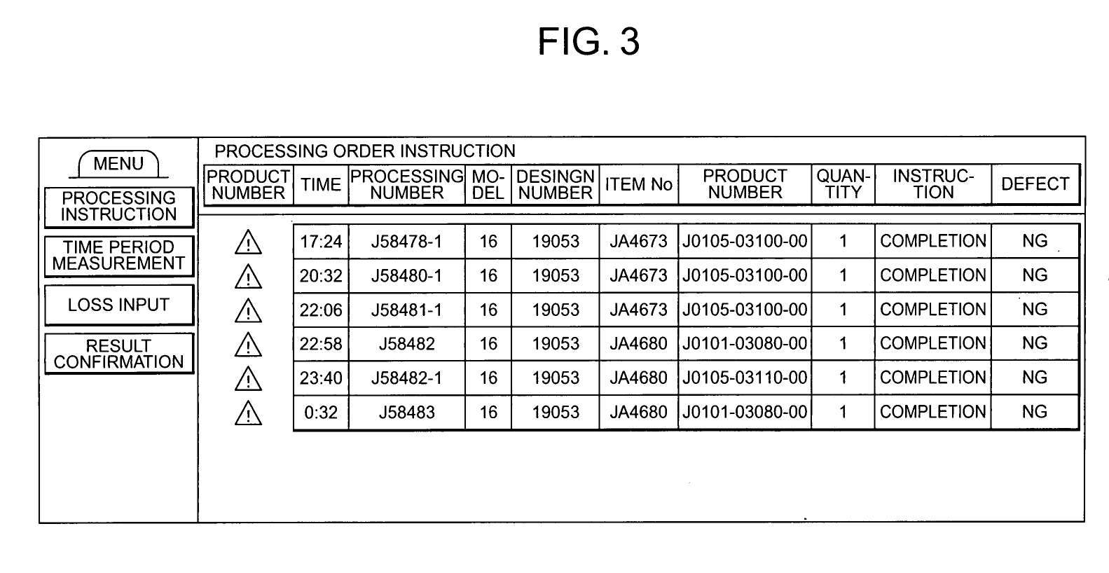

FIG. 3 shows an example of the work instructions displayed on the function panel devices 1a through 1c. In FIG. 3, a menu list is displayed in the left-hand end area. As menu items, there are provided “processing instruction”, “time period measurement”, “loss input” and “result confirmation”. These items are arbitrarily selected by the worker.

The records of processing order instruction are prepared for each product number and for each process. For example, in FIG. 3, the records of the uppermost through the third stages are dedicated to the same product number (J0105-03100-00) but differ from each other in work process (processing numbers: J58478-1, J58480-1, and J58481-1). That is, the work instructions indicate that three work processes are necessary for the product or part with this product number.

Further, for each record (that is, each process), the items of “actual measurement (indicated by symbol “!”)” through “quantity” are designated, and further, there are provided completion buttons and NG buttons. Here, symbol “!” indicates that actual measurement of the working time period is necessary. When starting the work of a process indicated by symbol “!”, the worker selects the item “time period measurement” from the menu. The measurement of the working time period will be described in detail below.

The item “time” in the work instructions informs the worker of the time at which the process concerned is to be started. Thus, when the designated time is attained, the worker starts the work of the designated process. Then, when the work of the designated process has been completed, the worker presses the completion button of the corresponding record on the display screen of the function panel device. The fact that the completion button has been pressed is registered in the database 11 of the server 10. Thus, the server 10 is capable of managing the progress of each progress. If there is any defect in the work (processing defect or material defect), the worker presses the NG button. As described below, when the NG button is pressed, the display is changed to a defect input screen.

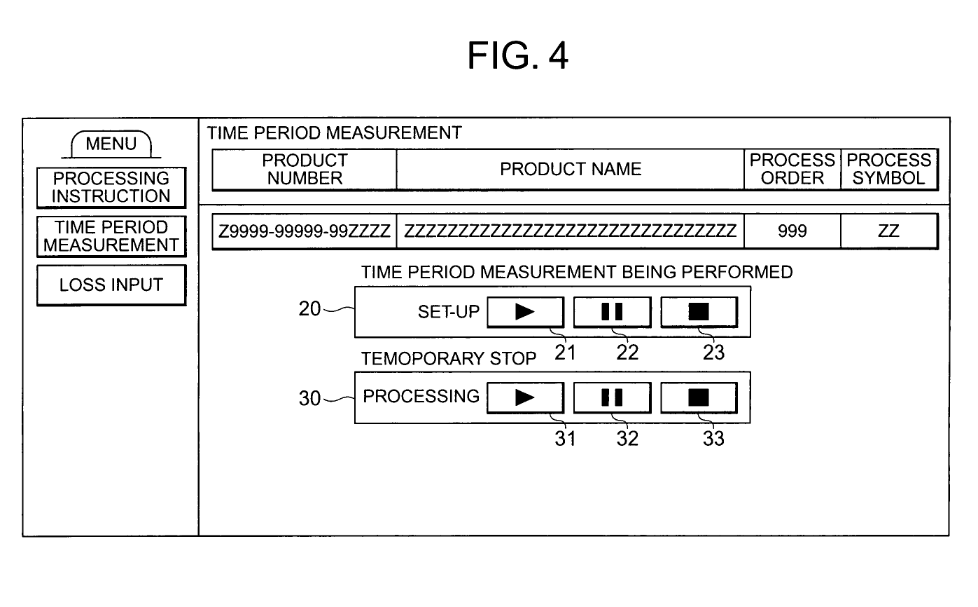

FIG. 4 shows a screen for inputting information for measuring the working time period (hereinafter referred to as the time period measurement screen) according to an example. This time period measurement screen is displayed when the item “time period measurement” in the menu is selected by the worker.

The time period measurement screen displays the product number, product name, process order, process symbol, etc. of the object of measurement, and further displays a set-up time period information input area 20 and a processing time period information input area 30. Here, in the set-up time period information input area 20, there are provided a start button 21, a temporary stop button 22, and a completion button 23. Similarly, in the processing time period information input area 30, there are provided a start button 31, a temporary stop button 32, and a completion button 33.

The worker presses the start button 21 when set-up work is to be started, and presses the start button 31 when processing work is to be started. Here, it is to be noted that the buttons (including the buttons 21 through 23 and 31 through 33) are adapted to be pressed on the display screen of the function panel device. The set-up work refers to a preparation work for making it possible to start processing work, and includes setting of the processing machine and adjustment of the jig. The processing work refers to a work for actually processing or assembling a product.

When the work is to be temporarily interrupted, the worker presses the temporary stop button 22 or 32. Further, when that work, temporarily interrupted, is to be re-started, the worker presses the start button 21 or 31 or the temporary stop button 22 or 32.

When the work is complete, the worker presses the completion button 23 or 33. It is to be noted that the completion button 33, which is pressed when processing work is completed, may also serve as the corresponding completion button of the work instruction screen shown in FIG. 3.

Information indicating the pressing of the buttons 22 through 23 and 31 through 33 is supplied to the server 10 as work information for measuring the working time period. Then, this information is stored in the database 11 together with information indicating the time at which each button was pressed.

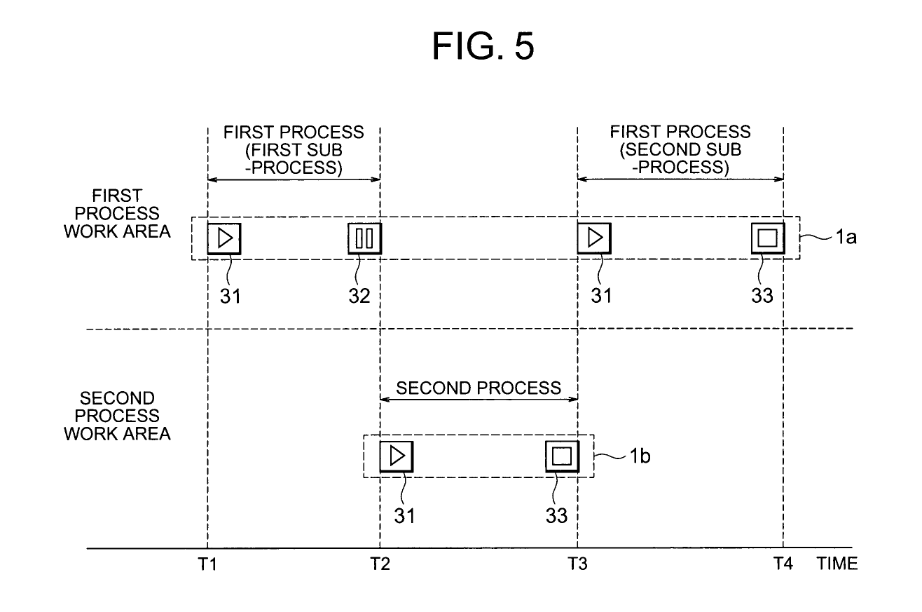

FIG. 5 is a diagram illustrating the operation of the worker when measuring the working time period. Here, it is to be assumed that a single worker executes the first process and the second process in parallel. Here, the first process is performed in the first process work area, and the second process is performed the second process work area. Further, in the first process work area and the second process work area, there are respectively installed the function panel devices 1a and 1b. Further, it is to be assumed that the following procedures are previously determined: the first process consists of two sub-processes; when the first process (a first sub-process) is completed, the second process is executed, and there after, the first process (a second sub-process) is executed.

The worker starts the first process at time T1. At this time, the worker presses the start button 31 of the function panel device 1a. Then, when, at time T2, the first process (the first sub-process) is completed, the worker presses the temporary stop button 32 of the function panel device 1a.

Subsequently, the worker moves to the second process work area and starts the second process. At this time, the worker presses the start button 31 of the function panel device 1b. Then, when, at time T3, the second process is completed, the worker presses the completion button 33 of the function panel device 1b.

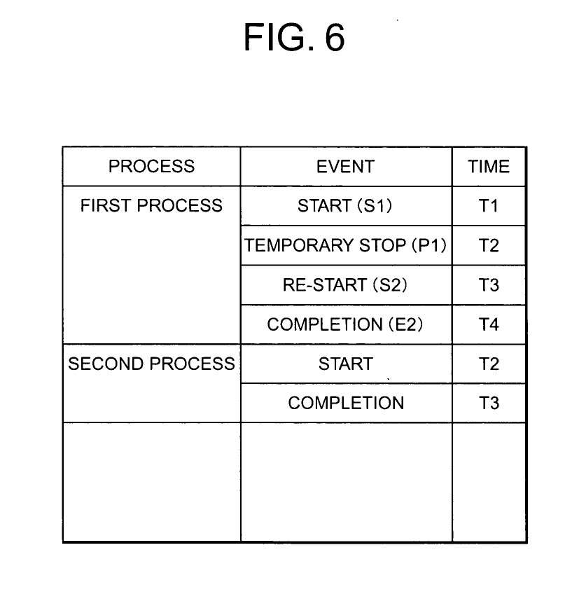

Further, the worker moves to the first process work area and re-starts the first process. At this time, the worker presses the start button 31 of the function panel device 1a. Instead of pressing the start button 31, it is also possible to press the temporary stop button 32. Then, when, at time T4, the first process is completed, the worker presses the completion button 33 of the function panel device 1a. As a result, the information as shown in FIG. 6 is registered in the database 11 of the server 10.

While in the above-described example the completion time of the first process (the first sub-process) and the start time of the second process are both time T2, this is to simplify the drawing and illustration. Actually, the second process is started after the completion of the first process (the first sub-process). Further, this also applies to time T3.

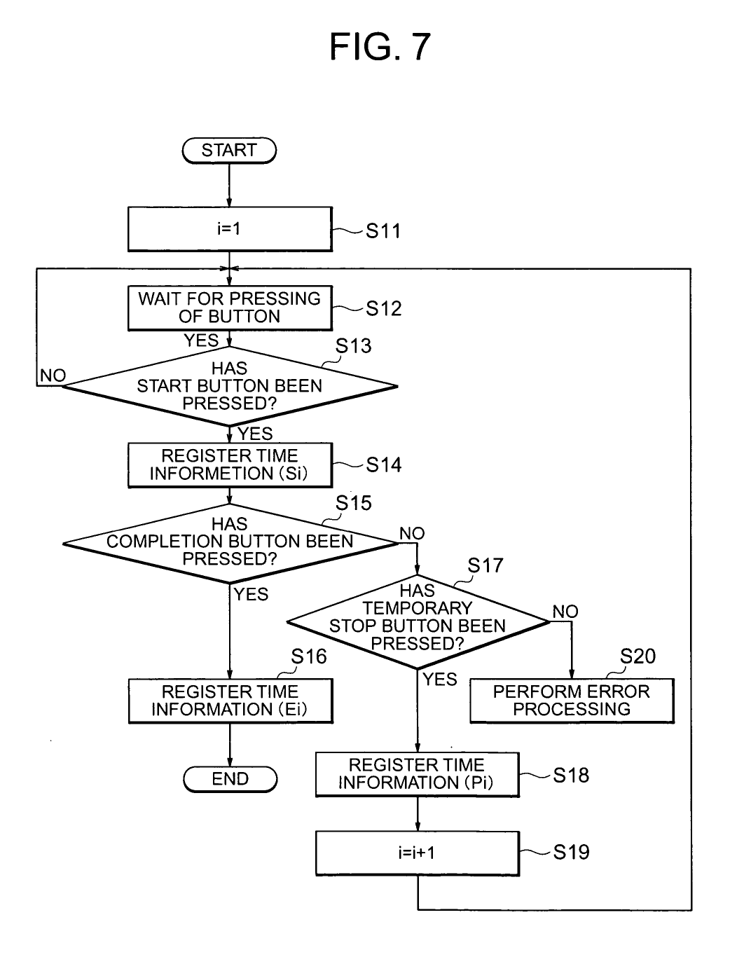

FIG. 7 is a flowchart showing the procedures for registering the work information transmitted through pressing of the buttons of the function panel devices. This processing is executed for each function panel device. Further, here, a case is shown in which the start button is pressed when a work that has been temporarily interrupted is to be re-started.

In step S11, variable i is initialized. Then, in step S12, pressing of a button in the corresponding function panel device is waited for.

In step S13, it is checked whether the button pressed in the corresponding function panel device is the start button or not. When the start button has been pressed, the time at which the start button was pressed is registered as time information S1 in step S14, and the next pressing of a button is waited for.

In step S15, it is checked whether the button pressed in the corresponding function panel device is the completion button or not. When the completion button has been pressed, the time at which the completion button was pressed is registered as time information Ei in step S16. When the button that has been pressed is not the completion button (i.e., the answer in step S15 is NO), the procedure advances to step S17.

In step S17, it is checked whether the button that has been pressed in the corresponding function panel device is the temporary stop button or not. In the case in which the temporary stop button has been pressed, the time at which the temporary stop button was pressed is registered as time information Pi in step S18. Then, in steps S19, the variable i is incremented, and the procedure returns to step S12. In the case in which the button that has been pressed is not the completion button (i.e., when the answer in step S17 is NO), error processing is executed in step S20.

When work information has been registered in the database 11 as described above, the detecting portion 12 calculates the working time period for each process. That is, when a process (e.g., the second process in FIG. 5) has been executed without being interrupted, the working time period is obtained by the following equation:
Working time period=Ei−Si(i=1)

When a process (e.g., the first process shown in FIG. 5) has been executed while undergoing interruption one time or more, the working time period is obtained by the following equation. The following equation is applicable to a case in which the process whose working time period is to be measured consists of j sub-processes. It is to be assumed that the second term on the right side is the accumulation sum with respect to the variable: i=2 to j−1.
Working time period=(P1−S1)+Σ(Pi−Si)+(Ej−Sj)

In this way, the detecting portion 12 is capable of detecting a working time period for each process based on the work information input through the function panel devices 1a through 1c. Thus, in the system of this embodiment, no measuring person for measuring the working time period is required; further, it is possible to grasp the working time period substantially in real time while continuing work. Further, the working time period detected is transferred to the preparing portion 13 to prepare or update the work instructions.

The description now returns to the operation of the function panel devices. When generation of a loss time period is to be expected, the worker selects the item “loss input” from the menu of the work instruction screen shown in FIG. 3. The term “loss time period” refers to a period of time during which continuation of work is substantially disabled due to a factor not directly related to the product manufacturing process. Here, examples of such a factor include maintenance of the processing machine and replacement of a worn tool.

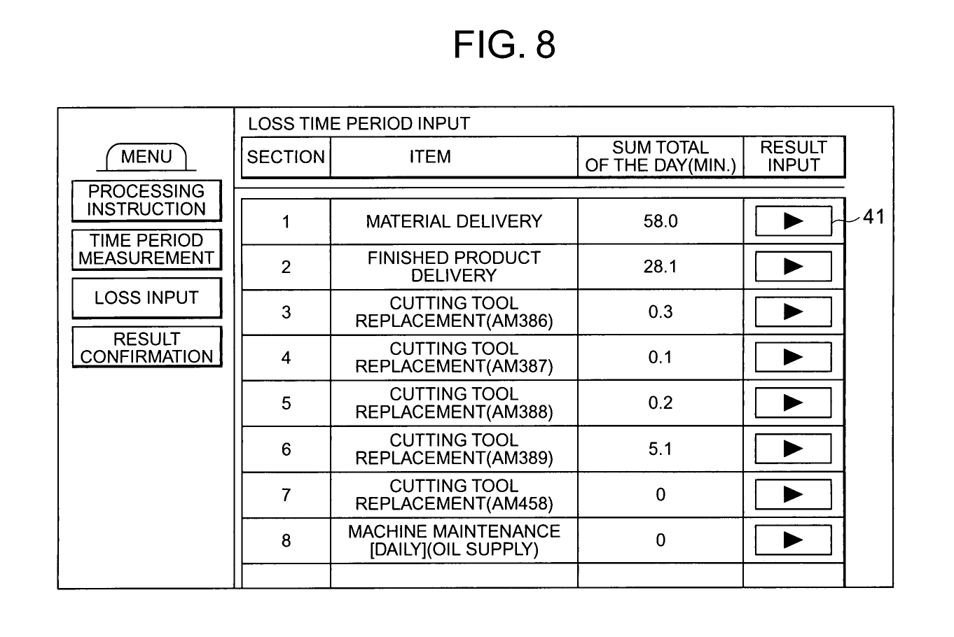

FIG. 8 shows an example of the loss time period input screen. The loss time period input screen is displayed on the function panel device when the item “loss input” is selected from the menu shown in FIG. 3. On the loss time period input screen, there are displayed loss time period buttons 41 for inputting start/completion timing for each loss time period factor. When the loss time period is to be started, the worker presses the loss time period button 41 of the corresponding record. Then, the display of the loss time period button 41 is changed to the mark “▪”. Thereafter, when the loss time period is terminated, the worker presses the loss time period button 41 of the corresponding record (indicated by the mark“▪”).

The server 10 is notified of the pressing of the loss time period button 41. Then, upon the notification, the server 10 registers the generated loss time period in the database 11 for each function panel device and for each loss time period factor. Then, the server 10 calculates the sum total loss time period value for each function panel device and for each loss time period factor. As shown in FIG. 8, the sum total loss time period value can also be viewed from each function panel device.

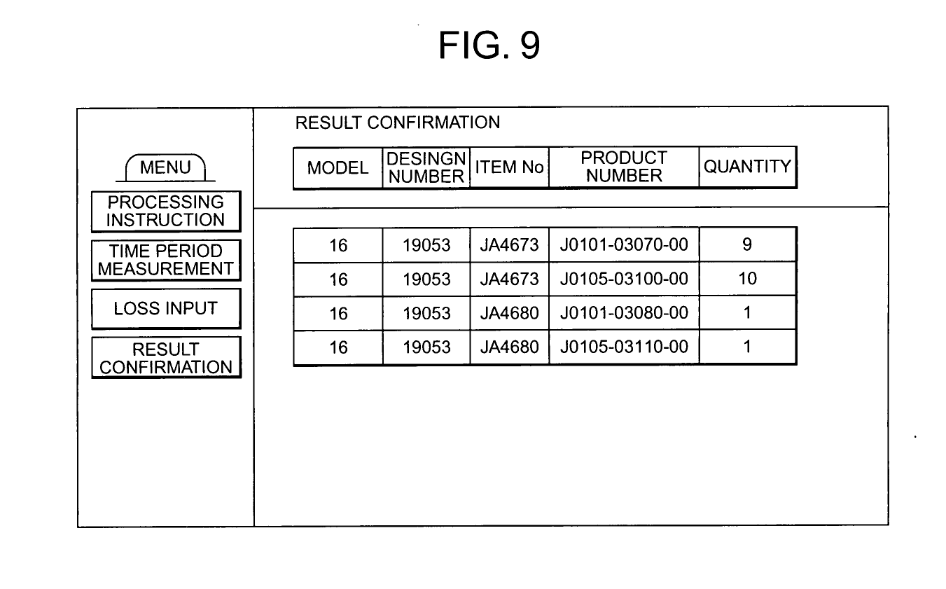

FIG. 9 shows an example of the result confirmation screen. The result confirmation screen is displayed on the function panel device when the item “result confirmation” is selected from the menu shown in FIG. 3.

The result confirmation screen displays the work completion quantity for each product or part. The data displayed on the result confirmation screen is managed by the server 10. That is, when the work related to a product or a part is completed, the worker notifies the server 10 of the completion by pressing the completion button on the work instruction screen shown in FIG. 3. The server 10 grasps the work completion number for each product or part in accordance with the notification from the function panel device and manages the same. Thus, the worker can confirm the progress and result of the work in his work area.

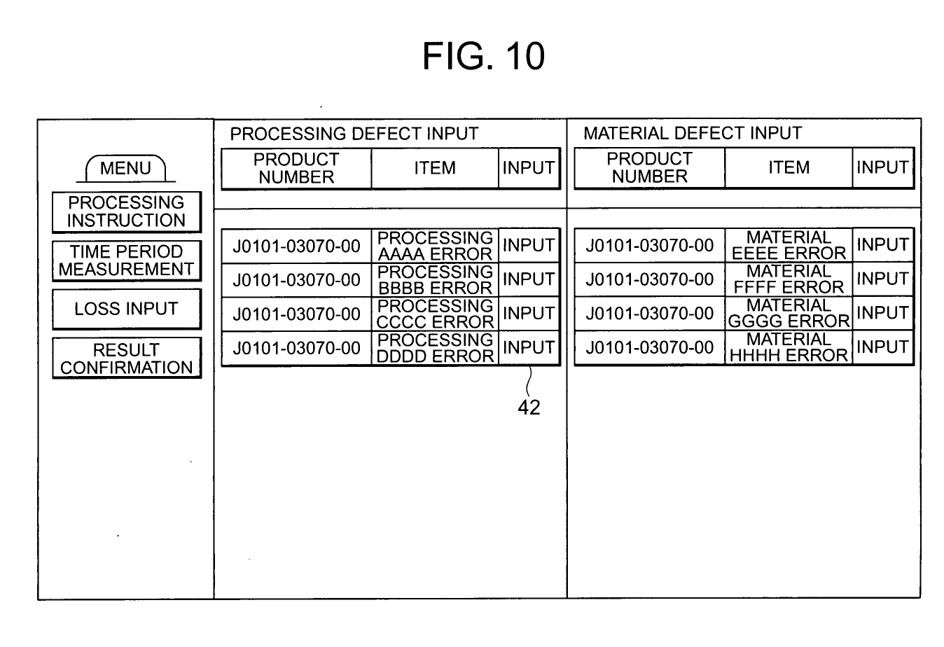

FIG. 10 shows an example of the defect input screen. The defect input screen is displayed when the NG button is pressed on the work instruction screen shown in FIG. 3 by the worker.

If, when carrying out a work in accordance with the work instructions shown in FIG. 3, a defect (processing defect or material defect) is generated, the worker presses the NG button of the corresponding record. This causes the defect input screen shown in FIG. 10 to be displayed on the function panel device. On the defect input screen, there is provided an input button 42 for each defect factor. The worker presses the input button 42 indicating the factor of the defect generated. As a result, the server 10 is notified of the defect generated in the work process.

When it receives notification about a defect from each function panel device, the server 10 generates data for analyzing the cause of the defect and presenting a solution. Further, as needed, the server 10 notifies the department concerned of instructions for recovering from the defect by E-mail or the like.

Next, the operation of the work instruction preparing system will be described. The work instruction preparing system includes the working time period grasping system described with reference to FIGS. 1 through 7 (in particular, FIGS. 4 through 7), and prepares work instructions based on the working time period for each process detected by the working time period grasping system. Further, when preparing work instructions, the work instruction preparing system takes the loss time period into consideration.

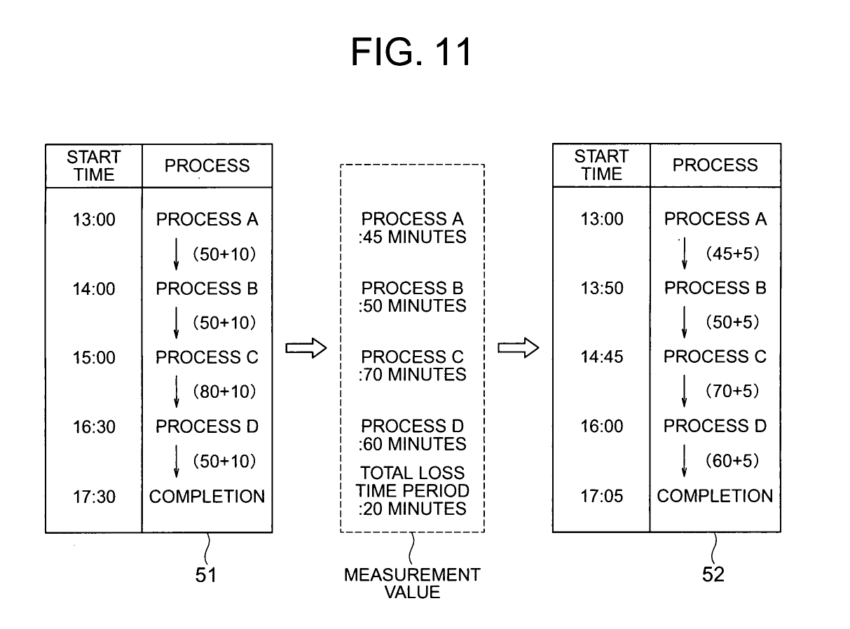

FIG. 11 is a diagram illustrating a method of preparing work instructions. Here, for the sake of clarity, the method will be described with reference to a simple model.

A work instruction 51 is a temporary work instruction prepared by using initial values prepared in advance. Here, as the initial values, working time periods and a loss time period measured in the past with respect to a similar work are used. In the example shown in FIG. 11, as the working time periods for processes A, B, C, and D, there are given “50 minutes”, “50 minutes”, “80 minutes”, and “50 minutes”, respectively. As the loss time period, there is given “40 minutes”, and this loss time period is uniformly allotted to the four processes, “10 minutes” for each. As a result, as the scheduled work start times for the processes A, B, C, and D, there are respectively set “13:00”, “14:00”, “15:00”, and “16:30”, and the scheduled completion time thereof is “17:30”.

The work instruction 51 is displayed on the function panel device provided in the work area where the processes A through D are executed, and the worker carries out the work in accordance with the work instruction. At this time, the worker inputs through the function panel device work information indicating the start, temporary stop, re-start, and completion of the work and loss information. The server 10 grasps the working time period and loss time period for each process based on the information input through the function panel device. Here, it will be assumed that the working time periods for the processes A, B, C, and D detected are “45 minutes”, “50 minutes”, “70 minutes”, and “60 minutes”, respectively, and that the loss time period detected is “20 minutes”.

The preparing portion 13 prepares a work instruction 52 based on these working time periods and the loss time. Here, the loss time period of “20 minutes” is uniformly allotted to the four processes, “5 minutes” for each. As a result, as the scheduled work start times for the processes A, B, C, and D, there are respectively set “13:00”, “13:50”, “14:45”, and “16:00”, and the scheduled completion time thereof is “17:05”. The work instruction 52 thus prepared is retained as the work instruction for the work from the next day onwards, and is displayed as needed on the corresponding function panel device.

In this way, the work instruction preparing system of this embodiment prepares work instructions based on the working time period and loss time period actually measured. Thus, it is possible to provide an efficient work plan in conformity with the actual conditions.

The work instruction 52 may be prepared each time the working time period and the loss time period are measured or may be prepared after repeated measurement of the working time period and the loss time period, utilizing the average values thereof, etc.

Further, it is also possible to adopt an arrangement in which, when the worker attempts to operate the function panel, the server 10 requires inputting of a worker ID of that worker. In this case, the server 10 can grasp the working time period for each process for each worker, making it possible to prepare a production plan and work instructions adapted to each worker.

Further, while in the above-described example the function panel device is a display device endowed with a touch panel function, this should not be construed restrictively. For example, the function panel device may also be a display device in which instructions of the worker are input by a pointing device such as a mouse.

Further, while in the above-described example the various buttons (buttons 21 through 23 and 31 through 33 shown in FIG. 4) are displayed on the screen, this should not be construed restrictively. For example, it is also possible to provide switches, etc. providing the same function as these buttons outside the screen of the display device (for example, adjacent to the display screen), allowing the worker to press them. In this case, work instructions are displayed on the display screen, so that the worker can perform input operation for time measurement while looking at the work instructions.

### EXAMPLE 2

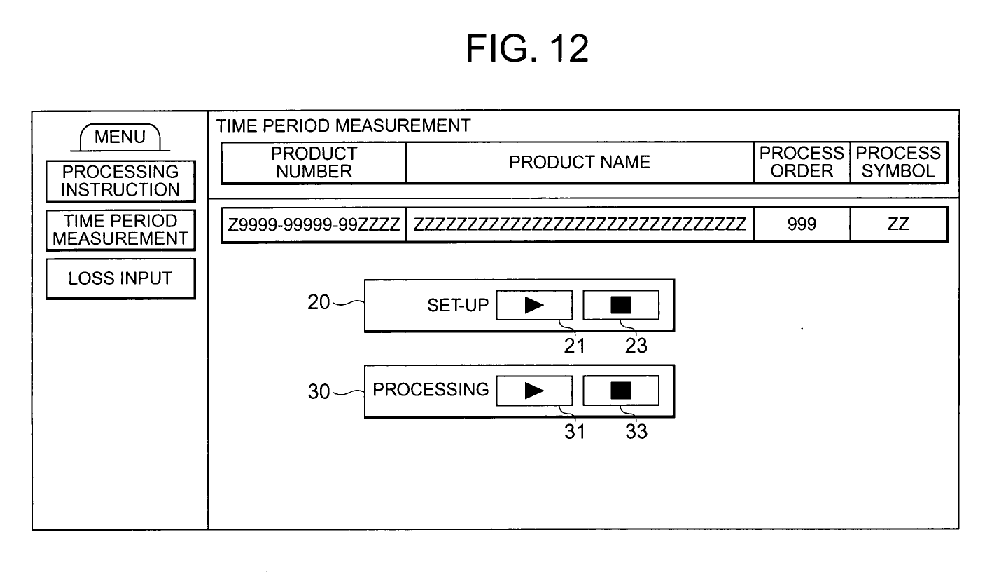

While in Example 1 described above there are provided on the time measurement screen the start buttons 21 and 31, the temporary stop buttons 22 and 32, and the completion buttons 23 and 33, the present invention is not restricted to this form. For example, as shown in FIG. 12, it is also possible to provide only the start button 21 and the completion button 23 in the set-up time period information input area 20 and to provide only the start button 31 and the completion button 33 in the processing time period information input area 30.

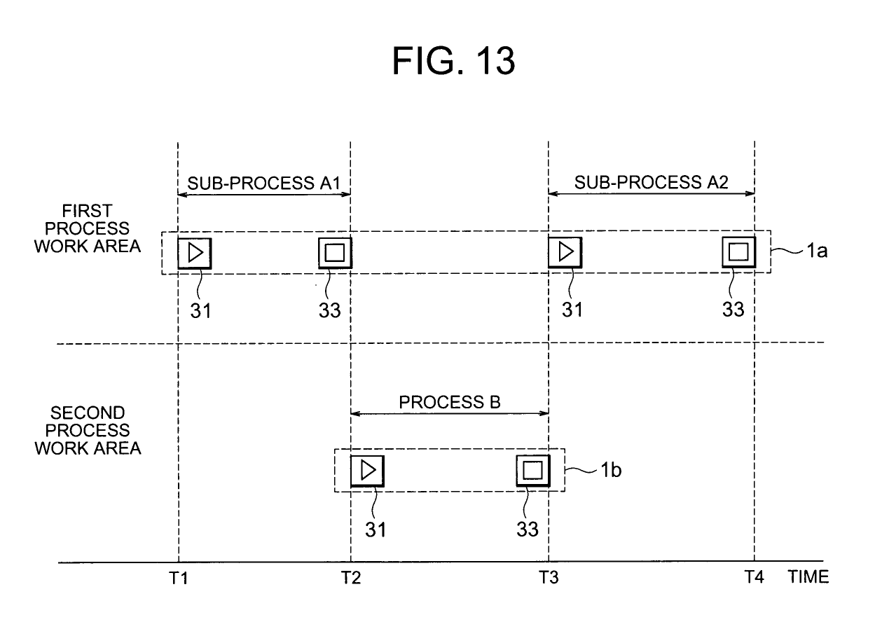

FIG. 13 is a diagram illustrating how the working time period is measured in Example 2. As to the work to be performed by the worker, it is as described with reference to FIG. 5.

In the system of Example 2, no temporary stop buttons are provided. Thus, if, when a single worker performs a plurality of processes (e.g., processes A and B) in parallel, one process (e.g., process A) is temporarily interrupted, the time measurement thereof involves a problem. In view of this, in Example 2, the process A is divided into a sub-process A1 and a sub-process A2, and the working time period is measured for each sub-process as follows.

When starting the process A at time T1, the worker presses the start button 31 of the function panel device 1a. Then, when the sub-process A1 of the process A is completed at time T2, the worker presses the completion button 33 of the function panel device 1a. Further, when re-starting the process A at time T3 (that is, when starting the sub-process A2 of the process A), the worker presses the start button 31 of the function panel device 1a. Then, when the process A is completed at time T4, the worker presses the completion button 33 of the function panel device 1a.

As in Example 1, the information input by using the function panel device is supplied to the server 10, and is stored in the database 11. The server 10 adds up the working time periods for the sub-processes for each process, thereby obtaining the working time period for that process. Due to this arrangement, while the server side processing becomes somewhat complicated, the possibility of the worker erroneously pressing the buttons is reduced.

1. A working time period grasping system comprising:
an input means having a start button for a worker to input start of a product manufacturing work and a completion button for the worker to input completion of the product manufacturing work; and
a time period detection means for detecting a working time period of the product manufacturing work based on information input from the input means.

2. A system according to claim 1, wherein the input means further includes a temporary stop button for allowing the worker to input interruption of the product manufacturing work, the detection means detecting the working time period based on information input from the start button, the completion button and the temporary stop button.

3. A system according to claim 1, wherein the input means comprises a display device on which the start button and the completion button are displayed and which is endowed with a touch panel function.

4. A system according to claim 2, wherein the input means comprises a display device on which the start button, the completion button, and the temporary stop button are displayed and which is endowed with a touch panel function.

5. A system according to claim 1, further comprising an output means for displaying work instructions at a predetermined position with respect to the input means,
the time period detection means detecting the working time period in correspondence with the work instructions displayed on the output means.

6. A system according to claim 1, wherein the product manufacturing work includes a plurality of processes, the input means being provided for a work area of each the process.

7. A work instruction preparing system comprising:
an input/output means for a product manufacturing work including a plurality of processes, the input/output means having a start button for a worker to input start of a work for each process and a completion button for the worker to input completion of the work;
a time period detection means for detecting a working time period for each process based on information input from the input/output means; and
a preparation means for preparing work instructions related to the product manufacturing work including the plurality of processes based on the working time period for each process detected by the time period detection means.

8. A system according to claim 7, wherein the input/output means displays the work instructions prepared by the preparation means.

9. A system according to claim 7, wherein the input/output means further includes a loss time period button for the worker to input start and end of a period not directly related to the product manufacturing work,
the time period detection means detecting a loss time period based on information input from the loss time period button,
the preparation means preparing the work instructions based on the working time period and loss time period for each process detected by the time period detection means.

10. A system according to claim 7, wherein the input/output means is provided for a work area of each process.
